(19) United States
(12) Patent Application Publication
(10) Pub. No.: US 2007/0011364 A1
(43) Pub. Date: Jan. 11, 2007

(54) Direct memory access controller supporting non-contiguous addressing and data reformatting

(75) Inventor: Martinus Cornelis Wezelenburg, Leuven (BE)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/173,162

(22) Filed: Jul. 5, 2005

(51) Int. Cl. G06F 13/28

(52) U.S. Cl. 710/22

(57) ABSTRACT

A direct memory access controller is provided that is operable to perform a data transfer to transfer target data from a source to a destination. The direct memory access controller comprises an address generator having a set of iterators comprising a sample iterator, at least one frame iterator and at least one block iterator. The address generator is operable to generate a sequence of non-contiguous addresses by performing nested iteration of the set of iterators in accordance with an iterator hierarchy. The direct memory access controller is operable to perform the data transfer such that the destination data format differs from the source data format.

### BACKGROUND OF THE INVENTION

1. Field of the Invention

This invention relates to data processing systems. More particularly, this invention relates to direct memory access controllers operable to perform data transfer operations.

2. Description of the Prior Art

It is known to provide direct memory access controllers that facilitate data transfer between functional units of a data processor independently of the central processing unit. Such known direct memory access controllers directly read or write between themselves and memory and can typically be programmed over memory-map registers to transfer multi-channel data from a serial interface to a contiguous region in memory.

However, many signal processing applications are adapted to receive data or transmit data, such as audio data or video data, according to particular compression/decompression algorithms having associated standardised data formats. The format in which data is output after processing by such data processing algorithms may differ considerably from the format in which it is required to output data for reproduction from a peripheral device. Similarly, in view of the standardised format upon which signal processing algorithms are configured to operate, it is desirable to store data received from a peripheral device in system memory in a format that is consistent with the appropriate standardised format. In addition, in the case of multi-modal processing, it is typical that the most advantageous memory-to-memory access pattern depends on the algorithm mode and has a format different from either the input/output or storage format. Examples of such standardised formats for audio data are MPEG, AAC and AC3. For video data such standardised formats include MPEG, H.263 and H.264.

In order to accommodate differences between data storage formats and required data input/output formats, known data processing systems either employ dedicated and non-shared hardware to perform format conversion or software is used to reorder data into an appropriate format, but this requires provision of additional buffering within the system, or in the case of a software solution, both compute cycles and program code space.

### SUMMARY OF THE INVENTION

Viewed from one aspect the present invention provides a direct memory access controller operable to perform a data transfer to transfer target data from a source to a destination said target data being stored at said source in a source data format and said data transfer has an associated data transfer format defined by at least a sample size corresponding to a number of bits per data sample, a frame size corresponding to a number of samples per frame and a block size corresponding to a number of frames per block, said direct memory access controller comprising:

an address generator having a set of iterators comprising a sample iterator for counting said number of bits per sample, at least one frame iterator for counting said number of samples per frame and at least one block iterator for counting said number of frames per block, said address generator being operable to generate a sequence of non-contiguous addresses for indexing said target data by performing nested iteration of said set of iterators in accordance with an iterator hierarchy;

wherein said direct memory access controller is operable to access data from said source in accordance with a target data access ordering corresponding to said generated sequence of non-contiguous addresses and is operable to output said accessed data to said destination in an output temporal sequence corresponding to said target data access ordering and corresponding to a destination data format that differs from said source data format.

The present technique recognises that provision of a direct memory access controller that is operable to generate a sequence of non-contiguous addresses by appropriate nested iteration of a set of iterators can be used for re-ordering of data such that the destination data format differs from the source data format of the data transferred by the direct memory access controller. The re-ordering of the data format via the address generation in the direct memory access controller obviates the need for dedicated hardware to perform the re-ordering and obviates the need for dedicated buffering that would otherwise be required to achieve a change from a storage data format to a different input/output data format. The change in data format is achieved in such a way that it allows data to be stored in memory in a format that is appropriate for the most widespread signal processing algorithms, yet allows redefinition of the data format for output to a peripheral device as required or the redefinition of the data format for internal processing as a function of a specific algorithm as required.

In one embodiment the direct memory access controller has a plurality of input ports for receiving said target data and the direct memory access controller comprises a plurality of the sets of iterators such that each set of iterators is associated with a single one of the plurality of input ports at a given time. Thus a single set of iterators is parameterised for a single input port (or physical channel) at a given time. However, the direct memory access controller can be configured to perform a switch (e.g. using a register or using software) in the mapping between input ports and sets of iterators. Note that although a set of iterators can be associated with a plurality of logical channels (e.g. user channels such as left and right audio channels), in this one embodiment only a single physical channel (i.e. input port) is associated with a given set of iterators at any one time.

In one embodiment the direct memory access controller is coupled to a communication bus and is operable to service data transfer requests issued by at least one of a plurality of peripheral devices connected to a communication bus.

In one embodiment the sample size, the frame size and the block size associated with the set of iterators, are all programmable. This provides a great deal of flexibility in implementing the direct memory access controller in systems such that the direct memory access controller may be used to re-order data corresponding to a wide variety of different standard data formats.

In one embodiment the iterator hierarchy is programmable to produce different nested iterations. This makes the direct memory access controller more generic by allowing the remapping between the source data format and the destination data format to be suitably defined according to the required implementation. The programmability of the iterator hierarchy enables the iterators to be dynamically configured as required by an algorithm.

In one embodiment the target data to be transferred by the direct memory access controller comprises audio data and is stored in a data format according to which the sample corresponds to an audio data sample, the frame corresponds to an audio data frame and the block corresponds to an audio data channel. A data format defined in this way conveniently accommodates the standard audio format within which all samples for a given audio channel are contiguously stored.

In an embodiment in which the target data comprises audio data the sample iterator counts bits of an audio sample, the at least one frame iterator comprises a frame iterator for counting audio samples of an audio frame and the at least one block iterator comprises a block iterator for counting audio channels. Such a set of iterators can be conveniently arranged to perform a nested iteration capable of converting audio data from a source data format in which all samples for a given channel are contiguously stored, to an input/output data format in which audio data corresponding to a given time slice (i.e. sample time), for each of a plurality of audio channels, is contiguously output.

In another embodiment in which the target data comprises audio data, the non-contiguous address sequence is generated by transposition of the frame iterator and the first block iterator in the iterator hierarchy. The transposition is defined relative to a non-transposed iterator hierarchy that corresponds to reproduction of a destination data format that is identical to the source data format. Such a transposition facilitates interleaving of channel data, such as left channel and right channel interleaving in the case of two audio channels. Such an interleaved input/output format is particularly useful since it corresponds to a desirable output format for reproduction of stored audio data.

It will be appreciated that the target audio data could comprise audio data selected from any one of a number of a plurality of different formats. However, in one embodiment the data format of data to be transferred comprises one of the following audio formats: MP3, AAC, AC3, ISO/IEC 11172-3, ISO/IEC 13818-3, ISO/IEC 13818-7, ISO/IEC 14496-3, WMA, SBC and SSACD. The use of one of these standard audio data formats promotes compatibility with common signal processing algorithms.

In one embodiment the data to be transferred by the direct memory access controller comprises video data and in the data format the sample corresponds to a video sample, the frame corresponds to a macroblock comprising a plurality of lines and a plurality of columns of video samples and the block corresponds to a video frame. This provides a straightforward mapping between the standard video format and transfer operations performed by the direct memory access controller.

In an embodiment in which the data to be transferred comprises video data, the direct memory access controller comprises a first frame iterator for counting macroblock columns, a second frame iterator for counting macroblock rows, a first block iterator for counting a number of macroblocks per image line and a second block iterator for counting the number of macroblocks per image column. The arrangement of the set of iterators in this way facilitates straight forward re-ordering of video data from a storage data format to an input/output data format by appropriate re-ordering of the iterators to produce different nested iterations during the address generation process. This enables data to be stored in memory according to a macroblock ordering, yet enables data to be output for video reproduction in an ordering that is consistent with the scanning of a video data frame. In one embodiment, the non-contiguous address sequence is generated by transposition of the second frame iterator and the first block iterator in the iterator hierarchy relative to a non-transposed iterator hierarchy corresponding to reproduction of a destination data format that is identical to the source data format.

It will be appreciated that the target data transferred by the direct memory access controller could be video data selected from any one of a number of different video data formats. However, in one embodiment the target data comprises one of the following video formats: MPEG, ISO/IEC 11172-2, ISO/IEC 13818-2, ISO/IEC 14496-2, ISO/IEC 14496-10, H.261, H.262, H.263, H.264 and WME. Use of one of the standard video formats enables applicability of the present technique to data processing systems employing such standard video compression/decompression algorithms.

Viewed from a second aspect the present invention provides a direct memory access controller operable to perform a data transfer to transfer target data from a source to a destination, said target data being stored at said source in a source data format and said data transfer has an associated data transfer format defined by at least a number of bits per data sample, a number of samples per frame and a number of frames per block, said direct memory access controller comprising:

an address generator having a set of iterators comprising a sample iterator for counting said number of bits per sample, at least one frame iterator for counting said number of samples per frame and at least one block iterator for counting said number of frames per block, said address generator being operable to generate a sequence of non-contiguous addresses for indexing said target data by performing nested iteration of said set of iterators in accordance with an iterator hierarchy;

wherein said direct memory access controller is operable to sequentially index a received sequence of target data from said source using said generated sequence of non-contiguous addresses and to supply said target data to said destination for storage at addresses corresponding to said generated sequence of non-contiguous addresses such that said target data is supplied to said destination in a destination data format that differs from said source data format.

Viewed from a further aspect the present invention provides a direct memory access controller operable to perform a data transfer from a source to a destination said data transfer having an associated data format defined by at least a number of bits per data sample, a number of samples per frame and a number of frames per block, said direct memory access controller comprising:

a source address generator having a set of source iterators comprising a sample iterator for counting said number of bits per sample, at least one frame iterator for counting said number of samples per frame and at least one block iterator for counting said number of frames per block, said source address generator being operable to generate a sequence of source addresses for indexing said target data received from said source device by performing nested iteration of said set of source iterators in accordance with a source iterator hierarchy; and

a destination address generator having a set of destination iterators comprising a sample iterator for counting up to said number of bits per sample, at least one frame iterator for counting up to said number of samples per frame and at least one block iterator for counting up to said number of frames per block, said destination address generator being operable to generate a sequence of destination addresses for indexing said target data to be written to said destination device by performing nested iteration of said set of destination iterators in accordance with a destination iterator hierarchy;

wherein at least one of said source address generator and said destination address generator is operable to generate a non-contiguous sequence of addresses.

The above, and other objects, features and advantages of this invention will be apparent from the following detailed description of illustrative embodiments which is to be read in connection with the accompanying drawings.

### BRIEF DESCRIPTION OF THE DRAWINGS

The present invention will be described further, by way of example only, with reference to the preferred embodiments thereof as illustrated in the accompanying drawings, in which:

FIG. 1 schematically illustrates a data processing apparatus comprising a direct memory access controller;

FIG. 2 schematically illustrates a single iterator operable to repetitively count up to a threshold value;

FIG. 3 schematically illustrates a direct memory access controller having a set of iterators comprising a sample iterator, a frame iteration and a block iterator;

FIG. 4 is a flow chart that schematically illustrates a sequence of events associated with a data transfer performed by the direct memory access controller of FIG. 1;

FIG. 5 schematically illustrates a data transfer operation performed by the direct memory access controller of FIG. 1;

FIG. 6 is a flow chart that schematically illustrates a data transfer from a peripheral device to a memory;

FIG. 7 schematically illustrates how the direct memory access controller of FIG. 1 is used to convert a source to audio data format to an input/output audio data format;

FIG. 8A to 8C schematically illustrate the difference between a multi-channel audio data storage format and a multi-channel audio data output ordering;

FIG. 8D schematically illustrates a multi-channel audio data output ordering in which address offsets have been used by the address generator to store different channels non-contiguously in memory;

FIG. 9 schematically illustrates an address generator within the direct memory access controller of FIG. 1 suitable for effecting the change between the storage data ordering of FIG. 8B and the input/output ordering of FIG. 8C;

FIGS. 10A and 10B schematically illustrate a storage ordering and an input/output ordering for video data;

FIG. 11A schematically illustrates the pixel structure of an individual macroblock;

FIG. 11B schematically illustrates the storage order of video data;

FIG. 11C schematically illustrates an input/output ordering of video data as required for output to a peripheral device;

FIG. 12 schematically illustrates an address generator and set of iterators suitable for converting video data from the storage ordering of FIG. 11B to the input/output video ordering of FIG. 11C;

FIG. 13 schematically illustrates a programmable iterator hierarchy;

FIG. 14A schematically illustrates transfer of data from a memory to a peripheral device using an address generator;

FIG. 14B schematically illustrates transfer of data from a memory to a peripheral to a memory using an address generator;and

FIG. 14C schematically illustrates transfer of data from one memory to another memory using an address generator.

### DESCRIPTION OF THE PREFERRED EMBODIMENTS

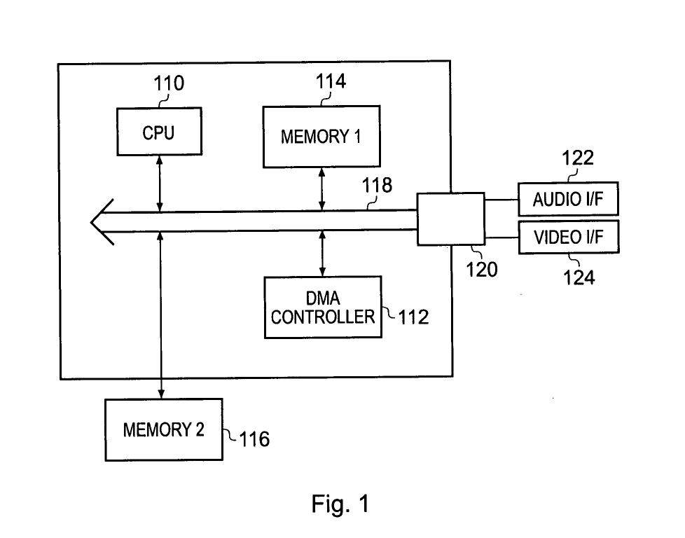

FIG. 1 schematically illustrates a data processing apparatus comprising a DMA controller according to the present technique. The data processing apparatus comprises a central processing unit (CPU) 110, a direct memory access (DMA) controller 112, a first memory 114, which is on-chip, a second memory 116, which is off-chip, a communication bus 118, an output interface 120, an audio interface 122 and a video interface 124.

The communication bus 118 enables data to be transferred between the CPU 110, the first memory 114 and the second memory 116. Data can be input to or ouput from the data processing apparatus via the interface 120. The DMA controller 112 facilitates data transfer between the first memory 114 and the second memory 116 independently of the CPU 110. In operation, when transferring data, the DMA controller 112 becomes the bus master and directs the reads or writes between itself and memory. The CPU 110 sets up the DMA controller 112 by supplying the identity of the input/output device (in this case either the first memory 114 or the second memory 116), from which data is to be read or to which data is to be written, and also supplies the memory address which is the source or destination of the data to be transferred. The CPU 110 also specifies to the DMA controller 112 the number of bytes of data to transfer.

Data is stored in the first memory 114 and the second memory 116 according to a particular storage configuration. Known DMA controllers would allow data to be output via the output interface 120 from the first memory 114 or the second memory 116 only in a configuration that is identical to the configuration in which it is stored in the respective memory. However, according to the present technique, the DMA controller 112 enables data to be output via the interface 120 in a destination data format that differs from the source data format where the source data format corresponds to the format, in which the data is stored in the memory. The audio interface 122 outputs data is an I²S serial audio interface. The video interface 124 outputs data to a screen according to a suitable video interface standard such as BT.656.

When the DMA controller 112 receives data to be transferred, it indexes that data using a set of iterators comprising a sample iterator for counting a number of bits per sample, at least one frame iterator for counting a number of samples per frame and at least one block iterator for counting the number of frames per block. The block size, frame size and sample size are all programmable. The DMA controller 112 can raise data transfer events at each of these levels of hierarchy i.e. blocks, frame or sample but can also be programmed to mask any of these transfer events categories in order to control the system interrupt rate.

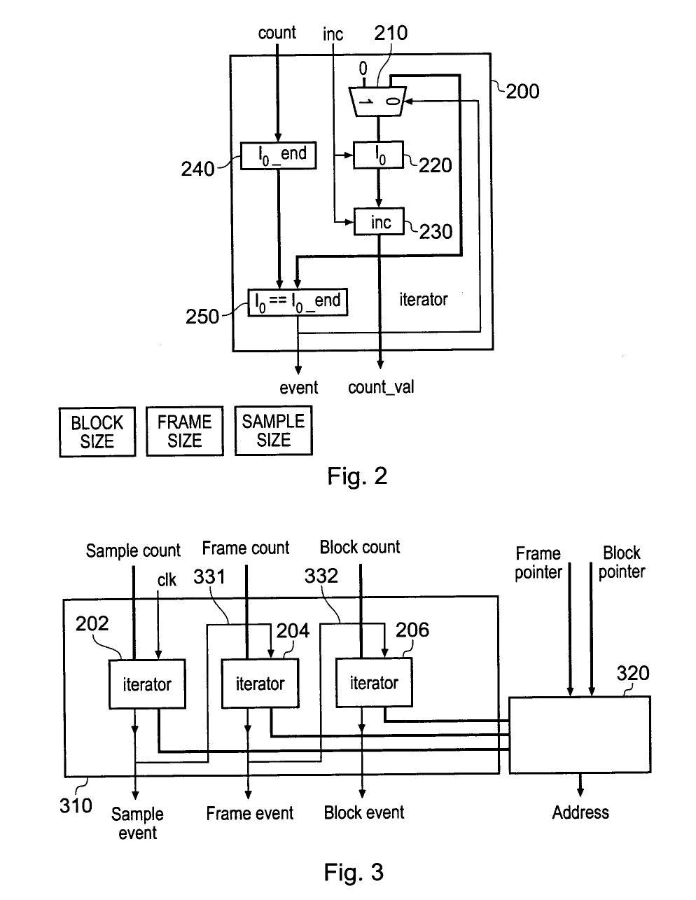

FIG. 2 schematically illustrates a single iterator operable to repetitively count up to a threshold value I₀_{_{—}}end. The incrementor comprises a multiplexer 210, a current count value block I₀ 220, an incrementer block 230, a threshold value store 240 and a threshold detecting block 250. The current value block 220 stores the current value of the count I₀, which is incremented repetitively in response the signal supplied to the current count value block 220 and to the incrementor block 230. After each increment, the value count_val is output by the incrementor block 230. The threshold value for the count is stored in the count threshold block 240. This threshold value would correspond to the number of bits per sample for the sample counter, the number of samples per frame for the frame counter or the number of frames for block for the block counter. In the condition testing block 250, it is determined whether or not the count value output by the incrementor block 230 is equal to the threshold count value I₀_{_{—}}end stored in the block 240. If the current count value is determined to be equal to the threshold value then the multiplexer 210 serves to reset the current count value to zero. This reset is achieved by feeding the signal from the output of the condition testing block 250 back to the multiplexer 210. Furthermore, when it is determined by the condition testing block 250 that the current count value is equal to the threshold value I₀_{_{—}}end a signal is output from the condition testing block 250 indicating that an event has occurred. In particular a word event in the case that the number of bits has reached the number of bits per sample, a frame event in the case where the number of samples has reached the number of samples per frame or a block event in the situation where there number of frames has reached the number of frames per block.

FIG. 3 schematically illustrates a direct memory access controller having a set of iterators comprising a sample iterator 202, a frame iterator 204 and a block iterator 206. The internal structure of each of the three iterators 202, 204 and 206 is identical to that iterator of FIG. 2. The threshold value for the sample iterator stored in the threshold block 240 of the iterator 202 corresponds to the number of bits per sample, whereas the threshold value stored in the iterator 204 corresponds to the number of samples per frame and the threshold value stored in the iterator 206 corresponds to the number of frames per block. The three iterators of FIG. 3 are arranged according to a hierarchical ordering that defines the way in which a nested iteration of the sample count, the frame count and the block count is performed by the direct memory access controller. Outputs of the three iterators 202, 204 and 206 are supplied to an address generation unit 320. The address generation block uses the count values generated by the three iterators to calculate and output a memory address from which to read data or a memory address to which to write data. A value corresponding to a frame pointer and a value corresponding to a block pointer are supplied as inputs to the address generation unit 320 as well as the outputs of the three iterators 202, 204 and 206. Provision of the frame pointer and the block pointer enables addresses to be generated such that, for example, data corresponding to a one frame is stored in a given memory region but data corresponding to a subsequent frame is non-contiguously stored in memory. Thus, the frame pointer and the block pointer serve as offsets for memory addresses.

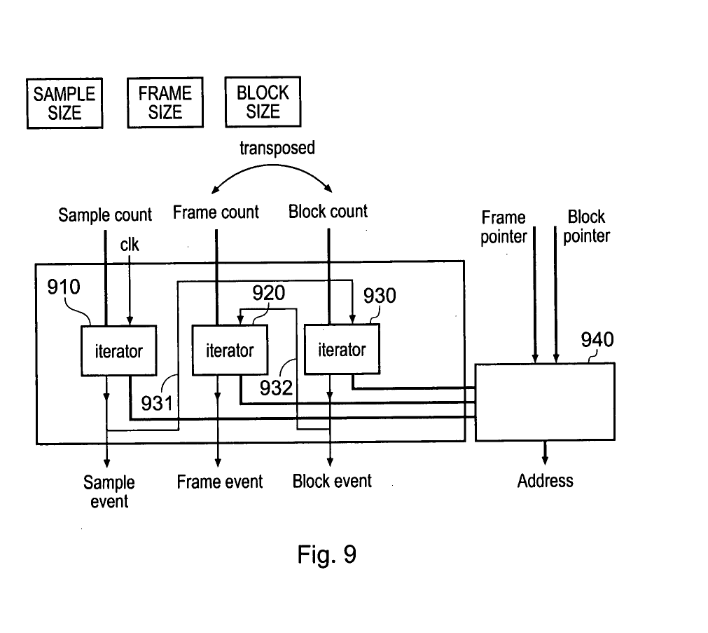

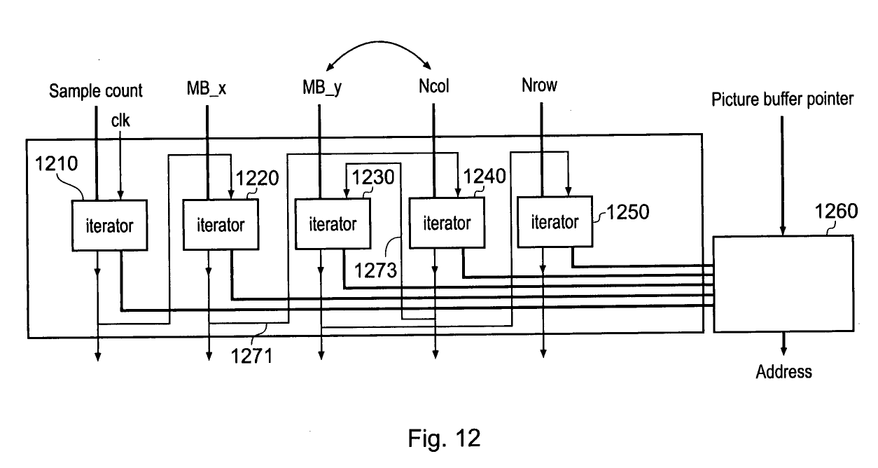

In the arrangement of FIG. 3, the sample counter is at the lowermost level of the iterator hierarchy, the frame counter is at an intermediate level of the iterator hierarchy and the block counter 206 is at the upper most level of the iterator hierarchy. Accordingly, the occurrence of a sample event is supplied from the sample iterator 202 at the lowermost hierarchical level, at the intermediate hierarchical level as an input to the frame iterator 204 and an output from the frame iterator 204 indicative of a frame event is supplied as an input to the block iterator 206 at the uppermost hierarchical level. Thus, on the occurrence of a sample event, the count within the frame iterator is incremented whereas on the occurrence of a frame event the counter within the block iterator is incremented. The nesting of the three iterators 202, 204, 206 in the arrangement of FIG. 3 corresponds to an unpermuted nesting order, the effect of which is to read output data to the destination in the same format as that data has been read from the source. As will be described later in relation to FIG. 9 and FIG. 12, according to the present technique the sample iterator, the frame iterator and the block iterator are transposed (or permuted) within the nested hierarchy of iterators such that the source data format associated with the target data transferred by the DMA controller differs from the destination format associated with the data output by the DMA controller 112 of FIG. 1.

In the arrangement of FIG. 3, although the iterators are unpermuted, non-contiguous addresses are generated by the address generation unit 320 by adding an offset address to at least one of the three iterators 202, 204, 206.

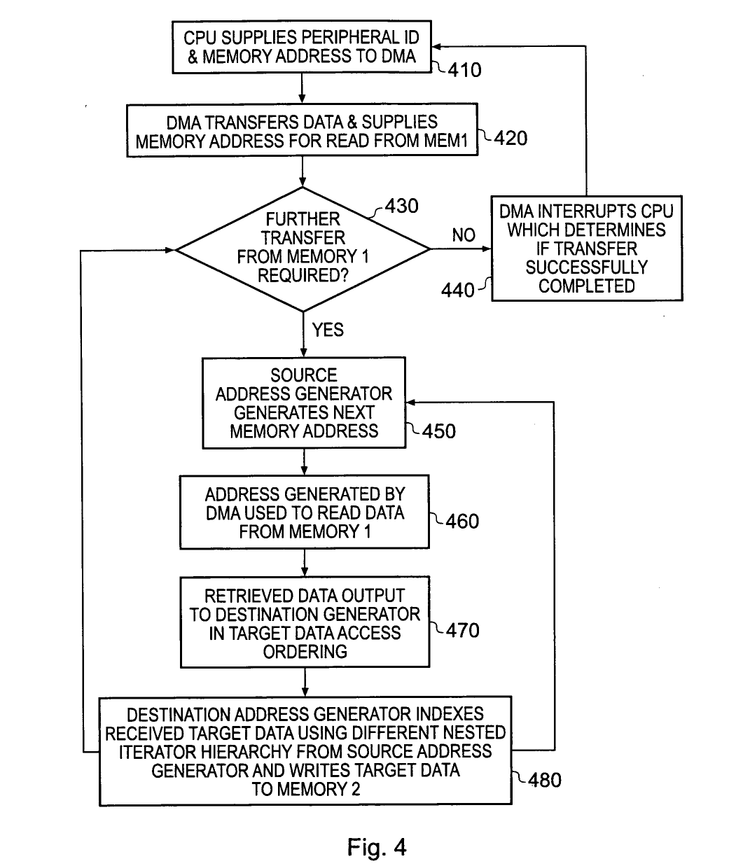

FIG. 4 is a flowchart that schematically illustrates a sequence of events associated with transfer of data by the DMA controller 112 of FIG. 1 from the first memory 114 to the second memory 116. The process begins at stage 410 when the CPU 110 supplies to the DMA controller 12, a peripheral identifier (in this case the identifier for the first memory 114) together with the memory address of the target data to be read from the first memory 114 and copied to the second memory 116. At stage 410 the CPU 110 also specifies to the DMA controller 112 the number of bytes of data that are to be transferred from the first memory 114 to the second memory 116. The process then proceeds to stage 420 whereupon the DMA controller 112 starts the data transfer operation by reading data from the first memory 114. In order to commence the data transfer operation, the DMA controller 112 performs arbitration to gain access to the communication bus 118. The DMA controller 112 supplies the memory address in the first memory 114 from which to read data. The DMA controller 112 also supplies the address within the second memory 116 to which the data retrieved from the first memory 114 should be written. The process proceeds to stage 430 where it is determined whether or not a further transfer of data from the first memory 114 to the second memory 116 is required. If a further transfer is not required, then the process proceeds to stage 440 whereupon the DMA controller 112 interrupts the CPU 110. In response to the interruption, the CPU 110 determines by interrogating the DMA controller 112 (or alternatively by examining the second memory 116) whether the entire transfer operation has completed successfully. The process then returns to the first stage 410 where the next transfer event is waited.

However, if at stage 430 it is determined that a further transfer from the first memory 114 is in fact required, then the process proceeds to stage 450 whereupon a source address generator within the DMA controller 112 generates the next memory address from which to read data from the first memory 114. The source address generator within the DMA controller 112 generates a sequence of memory addresses from which to retrieve data elements from the first memory according to the target data access ordering. Next, at stage 460 the address generated by the DMA controller 112 is used to retrieve the target source data from the first memory 460 for transfer to the second memory 112. Subsequently, at stage 470 the data retrieved from the first memory 114 is output to a destination address generator within the DMA controller 112. At stage 470, the retrieved data from the first memory 114 is output to a destination address generator within the DMA controller 112 according to the target data access ordering determined by the source data generator. Next at stage 480, the destination address generator within the DMA controller 112 indexes the received target data using a different nested iterator hierarchy from the iterator hierarchy used by the source address generator and thus writes target data to the second memory 116 in a destination data format that differs from the source data format. The stages 450, 460, 470 and 480 are performed in sequence for each memory read operation from the first memory 114 such that each read operation from the first memory 114 is read from a memory address generated by the source address generator and is then supplied to the destination address generator where it is indexed according to a destination address and written to the second memory 116 at a memory location corresponding to the generated destination address. Since the hierarchical ordering of the iterators within the source address generator differs from the hierarchical ordering of the iterators within the destination address iterator (i.e. the iterator nesting differs between the source address generator and the destination address generator within the DMA controller 112), the source data format according to which data is read from the first memory differs from the destination data format according to which data is written to the second memory by the DMA controller 112.

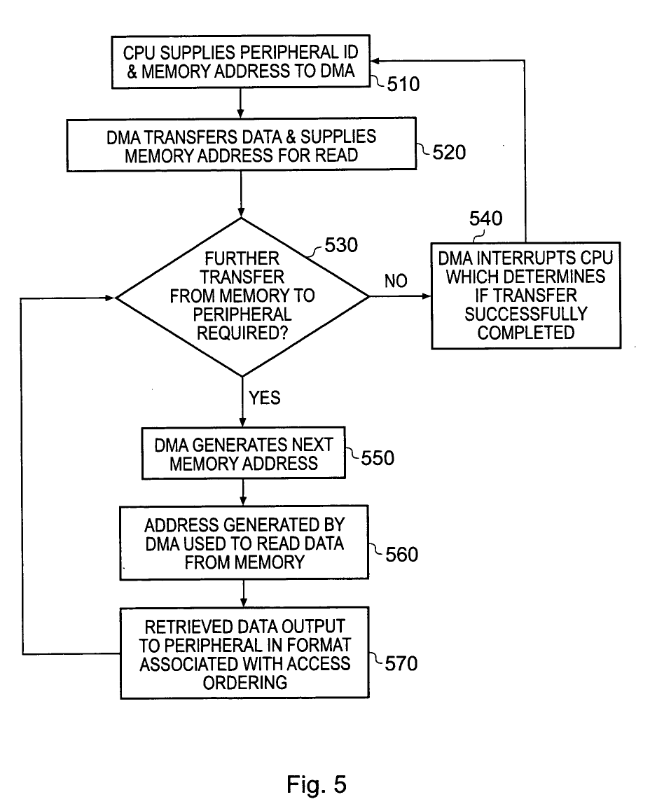

FIG. 5 schematically illustrates a data transfer operation performed by the DMA controller 112 whereupon data is transferred from the first memory 114 and supplied as output via the interface 120 to one of the interfaces 122 or 124. Thus, the sequence of steps in the flowchart of FIG. 5 corresponds to transfer of data from a memory to a peripheral device. The process begins at stage 510 whereupon the CPU 110 supplies to the DMA controller 112 an identifier for the peripheral to which data is to be transferred and also supplies a memory address from which data is to be read from the first memory 114 for supply to the peripheral device. The process proceeds to stage 520 whereupon the DMA controller 112 initiates the transfer by arbitrating for the buffer and supplies the memory address for reading of data from the first memory 114. Next, at stage 530, it is determined whether or not a further transfer from the first memory 114 to the peripheral device is required. If no further transfer is required, then the process continues to stage 540 whereupon the DMA controller 112 interrupts the CPU to determine whether or not the transfer event has completed successfully. The process then returns to stage 510 where a subsequent transfer event is awaited. If at stage 530 it is determined that the data transfer event has not yet completed but there is more data to be transferred, then the process proceeds to stage 550 whereupon the DMA controller 112 generates a next memory address from which to read target data from the first memory 114 for supply to the peripheral device. According to the present technique, a set of iterators within the DMA controller 112 of FIG. 1 are operable to generate a sequence of non-contiguous addresses for indexing the target data read from the first memory. The effect of generating the non-contiguous addresses is that data is output to the peripheral device according to a destination data format that differs from the source data format in which the data is stored in the first memory 114. Once a memory address has been generated at stage 550, the process proceeds to stage 560 and the generated address is used to read data from the first memory 114. Next, at stage 570, the data read from the first memory 114 is output to the peripheral device in a format associated with the target data access ordering that corresponds to the sequence of non-contiguous addresses that is generated by the address generator of the DMA controller 112. The process cycles through the stages 530, 550, 560 and 570 repetitively until all of the data to be transferred has been read from the first memory and output to the peripheral device. For each cycle after stage 570 has completed the process returns to the stage 530 whereupon it is determined whether or not a further transfer from the first memory to the peripheral device is required.

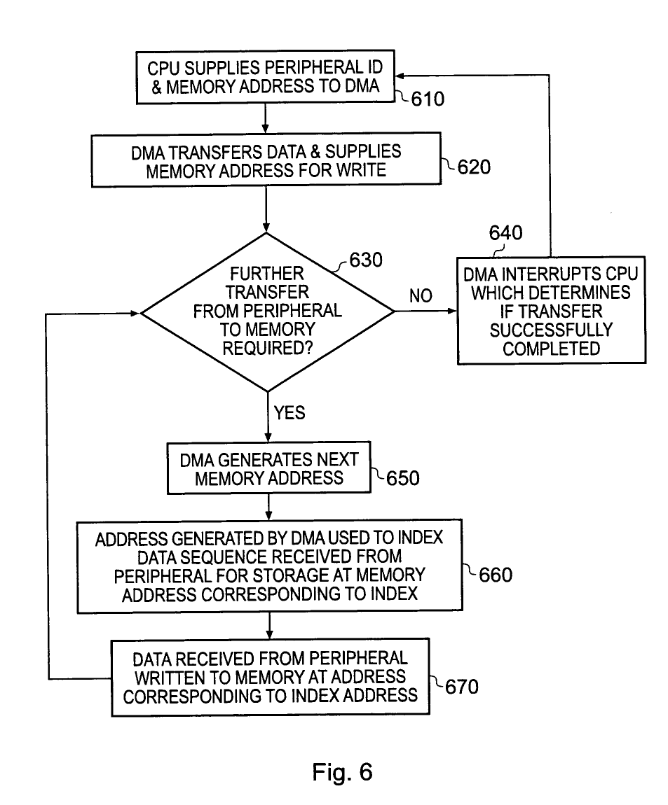

FIG. 6 is a flowchart that schematically illustrates transfer of data from a peripheral device to a memory. The process begins at stage 610 whereupon the CPU 110 supplies the peripheral identifier corresponding to the data source to the DMA controller 112 and also supplies the memory address within the second memory to which the data received from the peripheral device is to be written. Next at stage 620 the DMA controller 112 arbitrates for control of the communication bus 118 and effects the transfer of data from the peripheral device to the second memory 116 and supplies the memory address within the second memory 116 for the write operation. Next at stage 630 it is determined whether or not a further transfer from the peripheral device to the second memory 116 is required. If no further transfer is required, then the process proceeds to stage 640 whereupon the DMA controller 112 interrupts the CPU 110 so that the CPU can determine whether or not the data transfer has been successfully completed. On the other hand, if at stage 630 it is established that a further transfer from peripheral to the second memory is in fact required, then the process proceeds to stage 650 whereupon the DMA controller 112 generates a next memory address specifying where the next data item received from the peripheral is to be written in the second memory 116. At stage 660 the address generated by the DMA controller 112 is used to index the next sample of the received data sequence from the peripheral device. This data sample will be stored within the second memory 116 at an address corresponding to the generated index. The process then proceeds to stage 670 whereupon the data received from the peripheral is actually written to memory at the generated address index. The process then returns to stage 630 where it is determined whether or not a further transfer is required and if so a further memory address for storage of the transfer data will be generated in the subsequent stages.

The addresses generated by the DMA controller 112, which are used to specify storage locations in the second memory 116 for data received from the peripheral device, are non-contiguous addresses.

In the arrangement of FIG. 5, the non-contiguous addresses generated by the set of iterators within the DMA controller 112 are used to retrieve data from memory according to the generated sequence of non-contiguous addresses, whereas in the arrangement of FIG. 6 the non-contiguous addresses generated by the set of iterators are used to specify memory addresses at which to store data received in a given sequence from the peripheral device. In both cases the effect of the non-contiguous address generation within the DMA controller 112 is such that target data is supplied to the destination in a destination data format that differs from the source data format. The difference in source and destination data formats is achieved by changing the nested iteration of the iterators 202, 204 and 206 in FIG. 3 such that non-contiguous addresses are generated rather than a sequence of contiguous and monotonically increasing addresses.

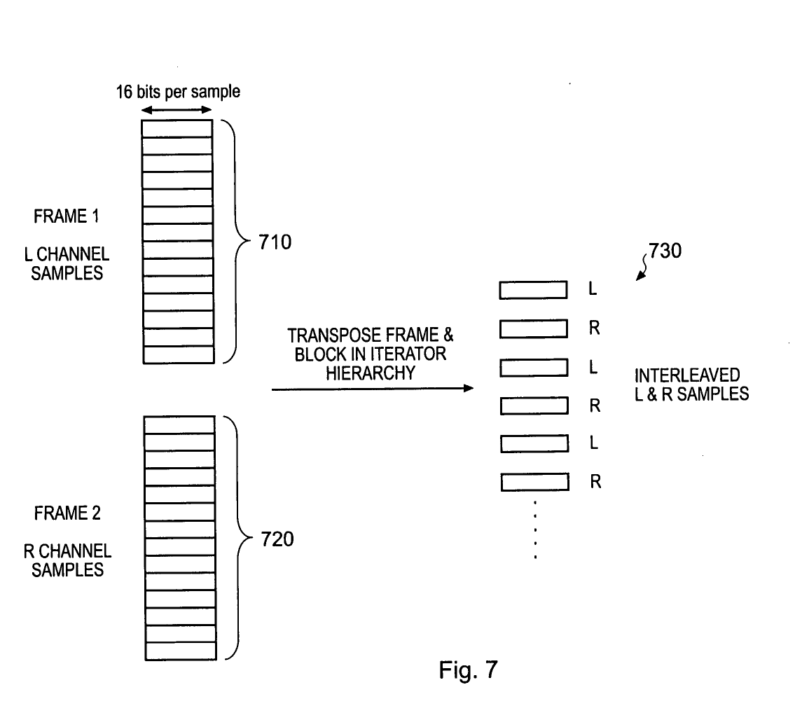

FIG. 7 schematically illustrates how the DMA controller 112 according to the present technique can be used to convert a source data format in which the left audio channel samples are contiguously stored and the right audio channel samples are contiguously stored to a destination data format in which samples of the left audio channel and samples of the right audio channel are interleaved for output to a peripheral device. In this simplified example each sample comprises 16 bits and a first audio frame 710 comprises 14 left audio channel samples and a second frame 720 comprises 14 right audio channel samples. In the MP3 audio format each sample comprises sixteen bits and each frame comprises 576 samples and the number of channels (which is equivalent in this case to the number of frames) varies between two and six. As shown in FIG. 7, the left audio channel samples 710, and the right audio channel samples 720, are re-ordered by the DMA controller 112 by reading those samples from memory according to the non-contiguous addresses generated by the set of iterators of the address generator of DMA controller 112, such that they are output to the peripheral device according to an output sequence in which samples are read alternately from the first frame corresponding to the left audio channel and the second frame corresponding to the right audio channel. Thus, the output of left and right audio channel samples is interleaved as shown in block 730. This output data format 730 differs from the source data format 710 and 720. The interleaved format 730 is suitable for playback by the peripheral device. In this case, the audio data samples are output via output interface 120 and the audio interface 122 for supply to the peripheral device.

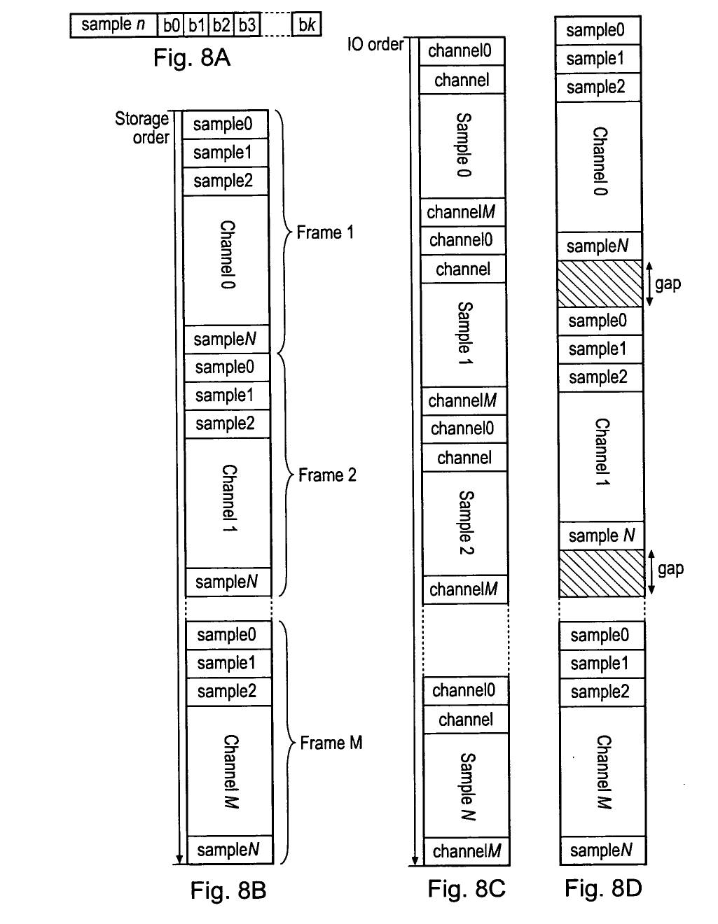

FIGS. 8A to 8C schematically illustrate the difference between a multi-channel audio data storage format and a multi-channel audio data output ordering. As shown in FIG. 8A, each audio sample comprises a plurality of bits from the first bit b0 up to the final bit bk. The number of bits per sample is variable and depends on the particular audio format. FIG. 8B schematically illustrates the storage ordering of the audio data. According to the storage ordering, all of the data samples corresponding to a particular audio sample are contiguously stored. Thus, for example, sample 0 to sample N of channel zero are contiguously stored, as are sample 0 to sample N of channel one; and sample 0 to sample N of the final channel, channel M. In this storage ordering of FIG. 8B, an audio channel can be considered to be a frame such that each frame comprises a plurality of samples corresponding to different sampling times. The number of samples per frame, and thus the frame size, is a property of the particular audio algorithm being used. For example, according to the MP3 audio format, there are 576 samples per frame whereas according to the AAC audio format, there are 1024 audio samples per frame. Other audio formats with which the direct memory access controller according to the present technique can be used include MP3, AAC, AC3, ISO/IEC 11172-3, ISO/IEC 13818-3, ISO/IEC 13818-7, ISO/IEC 14496-3, WMA, SBC and SSACD.

FIG. 8C schematically illustrates the input/output ordering of the audio data samples of FIG. 8B. As shown in FIG. 8C, the input/output ordering groups data for all channels for a given sample time. Thus, data corresponding to a given sampling time is contiguously stored. As shown in FIG. 8C, the 0^{th} sample for each of the 0 to M channels is collected together and output contiguously, then the data for all 0 to M channels of sample one is collected together and output contiguously and so on. This input/output ordering in which all channel data for a given sample time are concatenated is suitable for output to a real-time serial audio interface clocked at the audio analogue-to-digital/digital-to-analogue data rate. Note that in the storage ordering illustrated in FIG. 8B, the channel data can be stored in memory such that although data of a given channel is stored in a contiguous block, there is an offset between contiguous blocks for respective channels such that they occupy disjoint regions in memory.

FIG. 8D schematically illustrates an alternative input/output ordering of the audio data samples of FIG. 8B. In FIG. 8D, all samples of each individual channel are output contiguously but a gap is formed between channel 0 sample N and channel 1 sample 0 and between all other consecutive channels. This gap is formed by the address generator 320 using offsets when calculating the generated sequence of non-contiguous addresses. In this case, the iterator hierarchy is non-permuted as shown in FIG. 3. The use of address offsets enables the audio data for different channels (e.g. L-channel and R-channel data) to be stored non-contiguously in memory.

FIG. 9 schematically illustrates an address generator within the DMA controller 112 suitable for effecting the change between the storage ordering of FIG. 8B and the input/output ordering of FIG. 8C for output of audio data. Referring to FIGS. 8A and 8B, the storage data format is such that the sample counter counts up to (k+1) bits per sample, the frame counter counts up to N samples per frame and the block counter counts up to M frames per block. Thus, to output data in an identical ordering to the order in which it is stored in memory, the set of iterators would be arranged as in FIG. 3, such that the sample counter is at a lowermost hierarchical level, the frame counter is at an intermediate hierarchical level and the block counter is at an uppermost hierarchical level. However, as shown in the arrangement of FIG. 9, the change between the source data format of FIG. 8B and the destination data format of FIG. 8C is achieved by changing the nested ordering of the iterators such that the frame iterator and the block iterator are transposed relative to the arrangement of FIG. 3.

As shown in FIG. 9, the arrangement comprises the sample iterator 910, a frame iterator 920 and a block iterator 930, each of which supplies a count value to an address generator 940. The address generator is operable to output a value corresponding to a memory address from which data is to be read from the memory. The generated memory address is calculated in dependence upon a frame pointer and a block pointer which are supplied as input to the address generation unit 940. A sample event signal 931 output by the sample iterator 910 is supplied as input to the block iterator 930 and a block event signal 932 output by the block iterator 930 is applied as input to the frame iterator 920. Thus, it can be seen that the sample iterator is at the lowest hierarchical level, the block iterator 930 is at the intermediate hierarchical level and the frame counter is at the upper most hierarchical level of the set of iterators. Thus, the nesting of the iteration of the arrangement of FIG. 9 differs from the nested ordering of the iterators of FIG. 3. In particular, the frame iterator 920 of FIG. 9 is at the upper most hierarchical level whereas in FIG. 3 the block counter is at the upper most hierarchical level. The effect of switching the hierarchical levels of the frame iterator 920 and the block iterator 930 in the arrangement of FIG. 9 is to retrieve the desired input/output data ordering whereby data for all N channels corresponding to a given sampling time is output together to the peripheral device. The input/output ordering is achieved by reading data from memory according to a sequence of non-contiguous memory addresses generated by the set of iterators 910, 920 and 930. The sample size, the frame size and the block size are programmable within the direct memory access controller 112 and these programmable values correspond to the iterator thresholds (I₀_{_{—}}end in FIG. 2) for the sample iterator 910, the frame iterator 920 and the block iterator 930 respectively. The frame pointer provides an indirection to an array of frame pointer values whereas the block pointer provides an indirection to an array of block pointer values, such that the data can be stored in disjoint buffers within memory. In the arrangement of FIG. 9 one or more of the sample iterator 910, the fame iterator 920 and the block iterator 930 is configurable to add an address offset to an index associated with a data item.

In the arrangement of FIG. 9, the DMA controller 112 comprises a single set of iterators 910, 920, 930, which is configured to receive data from a single input port (i.e. physical channel) comprising a plurality of logical channels consisting of interleaved left-channel and right-channel audio samples (see FIG. 7). In this arrangement, although the data that the DMA controller 112 is configured to receive could be switched (e.g. using registers or software) such that it processes data associated with a different input port (physical channel), the set of iterators processes only data associated with a single input port at any one time. In alternative embodiments the DMA controller 112 comprises a plurality N of input channels and a plurality M of sets of iterators, where M≦N. In this alternative embodiment, the DMA controller 112 is capable of performing up to M data transfer operations in parallel and can support a number of point to point links (input to output) equal to the number of input ports (physical channels). To increase bandwidth, each of the parallel processing paths has an associated bus.

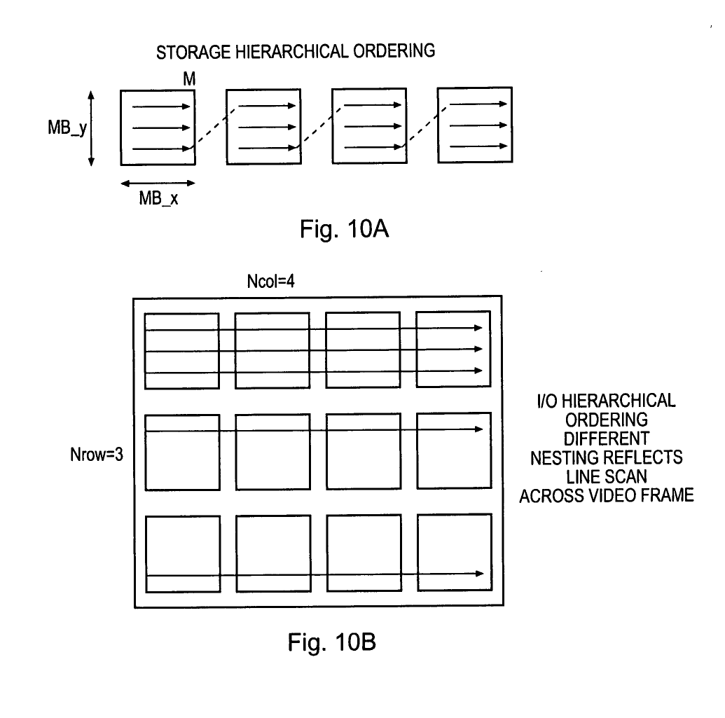

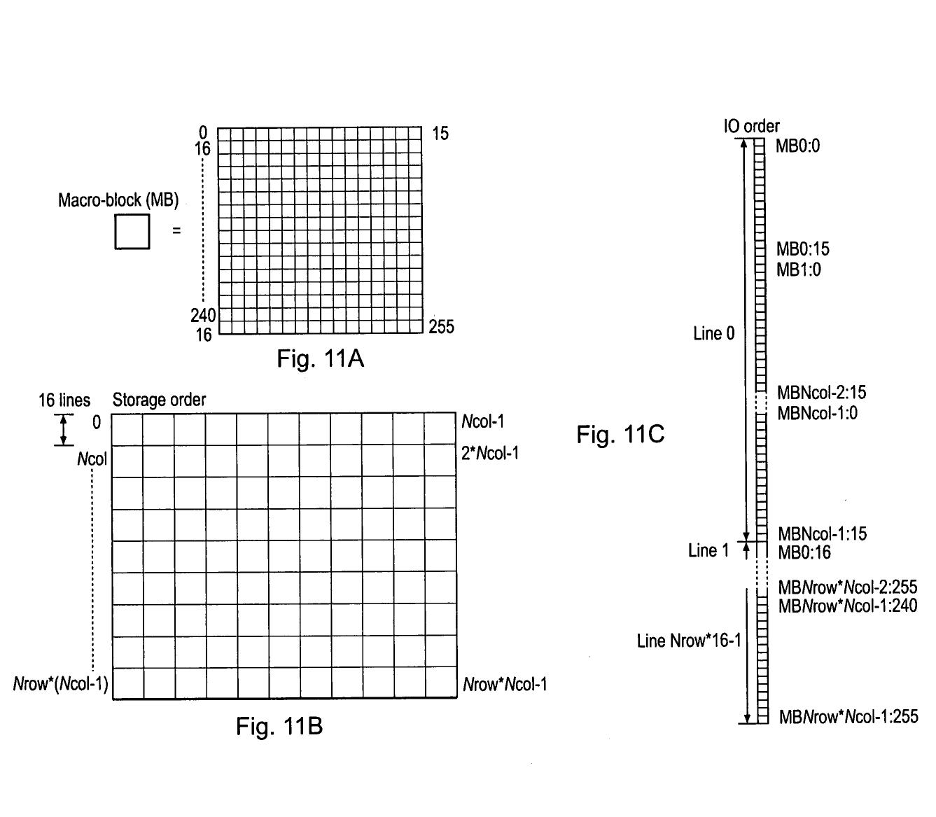

FIGS. 10A and 10B schematically illustrate a storage ordering and an input/output ordering for video data according to the present technique. FIG, 10A schematically illustrates four macroblocks of video data. As shown in FIG. 11A, an individual macroblock corresponds to a 16 by 16 block of pixels. Associated with each pixel is a luminance sample and two chrominance samples. In FIG. 10A, the macroblock has been simplified such that it is represented to consist of three lines rather than sixteen. The parameter MB_x corresponds to the number of pixels per macroblock line whereas the parameter MB_y corresponds to the number of pixels per macroblock column. The video data is stored in memory such that data associated with a given macroblock is contiguously stored. Thus, without re-ordering, data output from memory in this storage data format will be such that data from successive rows of one macroblock is read out and when the last line of a given macroblock has been reached, the first line of the next macroblock is subsequently read out as illustrated in FIG. 10A. However, it will be appreciated that for supply of video data to a peripheral device for output to a video display device, rather than outputting all data from a given macroblock before proceeding to output data from a subsequent macroblock, it is convenient for the order of data readout to be such that it reflects the order of the video scan. This is illustrated in the FIG. 10B.

As shown in FIG. 10B, a video frame corresponds to (in this simplified example) four macroblocks across the screen and three macroblocks down the screen. Thus, in this case, the number of macroblocks per row Ncol is equal to four whereas the number of macroblocks per column Nrow is equal to three. In order to reproduce the video scan sequence, it is desirable to output the data according to a pixel ordering such that all pixels corresponding to pixels along the first row of all four macroblocks that span the width of the screen are read out before the pixels of the second row of the first macroblock. Thus, rather than proceeding from the first row of each macroblock to the last row of each macroblock before reading out the data from the first row of the subsequent macroblock, it can be seen that in FIG. 10B, the data is output such that samples of the first row of each of the four macroblocks along the uppermost line of four macroblocks spanning the width of the video frame are read out followed by subsequent rows of samples for each of those four macroblocks. The output ordering then proceeds to the first row of each of the four macroblocks corresponding to the second row of macroblocks of the video frame and so on. The scan proceeds in this way until the last pixel of the last macroblock associated with the bottom right hand corner of the video frame has been read out. The direct memory access controller according to the present technique can be used on data in many different video formats including: MPEG, ISO/IEC 11172-2, ISO/IEC 13818-2, ISO/IEC 14496-2, ISO/IEC 14496-10, H.261, H.262, H.263, H.264 and WME.

FIG. 11A schematically illustrates the pixel structure of an individual macroblock. FIG. 11B schematically illustrates the storage order of video data whereas FIG. 11C schematically illustrates the input/output order of video data as required for output to peripheral device. FIG. 11A shows that a macroblock comprises a 16-by-16 block of pixels comprising a total of 256 pixels of video data samples. Associated with each pixel is the luminance sample and two chrominance samples. Note that video codecs operate on 4:2:0 sub-data whereas output devices operate on 4:4:4 video data. The transition between the different sub-sampling formats can be achieved by interpolation. FIG, 11B schematically illustrates a video frame having Ncol=11 macroblocks spanning a row of the video frame and Nrow=9 macroblocks spanning the height of a video frame. As explained above in relation to FIG. 10A, the pixel data from a given macroblock is read out contiguously such that the storage order proceeds from the macroblock at the uppermost left-hand corner of the screen along the first row of the screen and down to the leftmost macroblock in the subsequent row of the screen and so on progressively until the macroblock at the bottom right-hand corner is reached.

FIG. 11C schematically illustrates a desired output ordering of the macroblock data for supply to a peripheral device for output to a video reproduction apparatus. As shown in FIG. 11C, the input/output ordering is such that pixels 0 through 15 of the first row of the 0^{th} macroblock are output followed by pixels 0 through 15 of the first row of the second macroblock and so on through to pixels 0 through 15 of the first row of the (Ncol−1)th macroblock, which is the last macroblock of the 0^{th} line of the video frame. Pixel values along lines of the video frame are read out contiguously as shown in FIG. 11C, such that the last pixel value to be read out is the bottom right-hand corner pixel of the video frame. In an alternative output ordering to that illustrated in FIG. 11C, the first four rows (i.e. raster-scan lines) in all of the macroblocks that define an image are accessed before proceeding to a second group of four rows.

FIG. 12 schematically illustrates an address generator and set of iterators suitable for converting video data from the storage ordering as illustrated in FIG. 11B to the input/output video ordering as illustrated in FIG. 11C. The set of iterators required to output video data in the required format comprises a total of five iterators (compare with the set of 3 iterators of FIG. 9 for audio data). In particular, the set of iterators comprises a sample iterator 1210, a macroblock row iterator 1220, a macroblock column iterator 1230, a video frame row iterator 1240 and a video frame column iterator 1250. Each of these five iterator outputs an event signal to an address generator 1260, which generates a memory address in dependence upon an input corresponding to a picture buffer pointer. The sample iterator 1210 counts up to the number of bits per sample, the macroblock row iterator counts up to the number of pixels per macroblock row (i.e. 16), the macroblock column counter counts up to the number of pixels per macroblock column (i.e. 16), the video frame row iterator 1240 counts up to the number Ncol of macroblocks per video line and the video frame column iterator 1250 counts up to the number Nrow of macroblocks spanning the column of the video frame. Thus, in this case, the DMA controller 112 comprises two frame iterators 1220 and 1230 and further comprises two block iterators 1240 and 1250. In order to output the data read from memory according to a destination data format that is identical to the storage data format of FIGS. 10A and 11B, the hierarchical ordering of the iterators of FIG. 12 would be such that the sample iterator 1210 is at the lowermost hierarchical level, the macroblock row iterator 1220 is at the next highest hierarchical level, the macroblock column iterator 1230 is at the next highest hierarchical level, the video frame line iterator 1240 is at the next hierarchical level and finally the video frame column 1250 is at the uppermost hierarchical level. However, to achieve the desired change between the source data format and the destination data format the nesting of the iterators is changed in the arrangement of FIG. 12 such that the hierarchical ordering of the macroblock column iterator 1230 and the video frame line iterator 1240 have been transposed. This is evidenced by the fact that the event signal 1271 output by the macroblock row iterator 1220 is supplied as input to the video frame line iterator 1240 rather than to the macroblock column iterator 1230. Similarly the event output signal 1273 of the video frame line iterator 1240 is supplied as input to the macroblock column 1230 rather than to the video frame column iterator 1250. In the address generator of FIG. 12, one or more of the set of five iterators 1210, 1220, 1230, 1240 and 1250 is operable to add an address offset to an index associated with a data item.

The address generators illustrated in FIGS. 3, 9 and 12 and described above are shown to have particular iterator hierarchies and the nesting of the iterators is illustrated by the various input/output connections. Some arrangements according to the present technique have fixed iterator hierachies in which the configuration of inputs and outputs between different iterators of the set is static. However, in alternative arrangements according to the present technique, the iterator hierarchy is programmable such that the nested iteration associated with the hierarchy can be dynamically configured by a program application.

The DMA controller 112 of FIG. 12 can be adapted such that it comprises a plurality of sets of iterators arranged to receive data via a plurality of input channels (physical channels). Such an alternative arrangement is capable of performing a number of data transfer operations in parallel and is capable of storing a set of configuration parameters for each of the plurality of sets of iterators. In such an arrangement either, the data associated with each input port is associated with a given set of iterators at any one time.

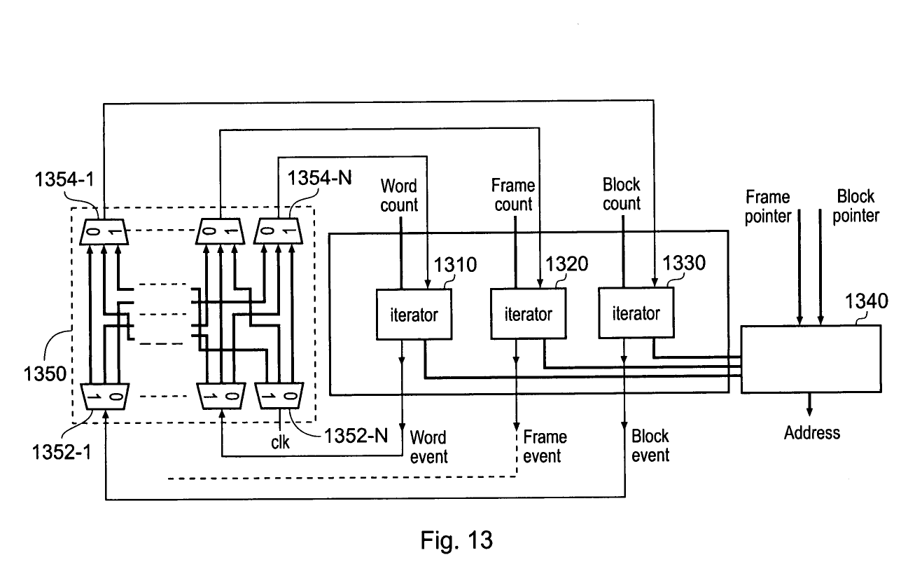

FIG. 13 schematically illustrates a programmable iterator hierarchy according to the present technique. The arrangement comprises a set of three iterators 1310, 1320, 1330, an address generation unit 1340 and a switching network 1350. The switching network 1350 comprises: a first array of N multiplexers 1352-1 to 1352-N arranged to receive outputs from respective ones of the three iterators 1310, 1320, 1330; and a second array of N multiplexers 1354-1 to 1354-N arranged to receive signals switchably supplied as inputs via the first array of multiplexers. The second array of multiplexers 1354-1 to 1354-N in turn switchably supplies those signals as inputs to respective ones of the array of iterators 1310, 1320, 1330. By appropriate configuration of the switching network 1350, a plurality of different iterator hierarchies can be implemented including the particular example configurations of FIG. 3 and FIG. 9. The routing of the signals via the switching network 1350 is programmable such that the iterator hierarchy can be dynamically configured by a program application. A similar switching network can be used with the address generator illustrated in FIG. 12.

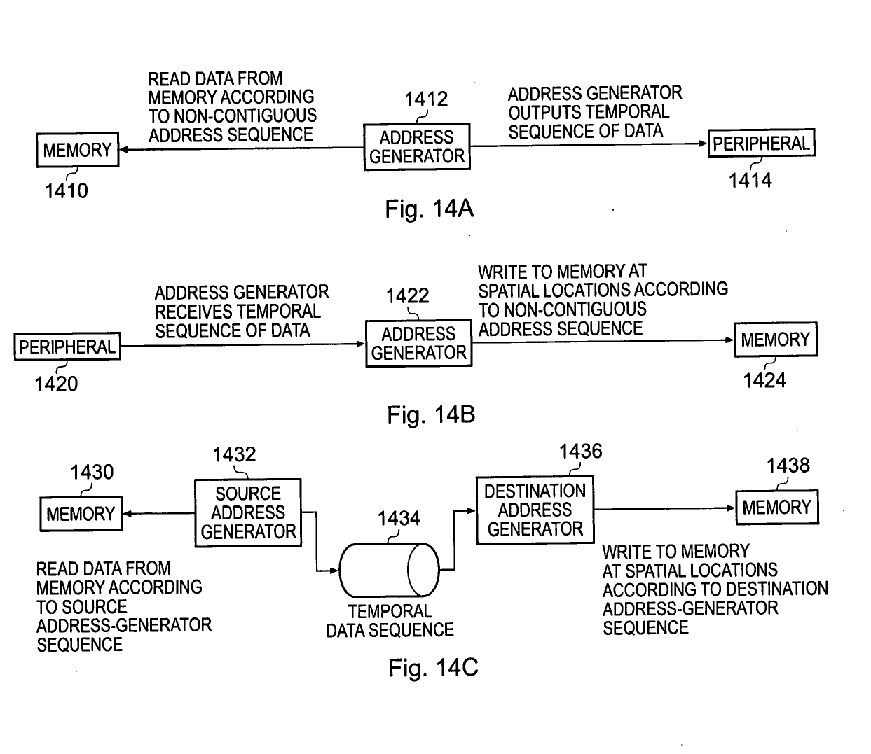

FIG. 14A schematically illustrates transfer of data from a memory to a peripheral device using an address generator according to the present technique. The arrangement of FIG. 14A comprises a memory 1410, an address generator 1412 and a peripheral device 1414. The memory 1410 is the source from which target data is read for transfer to the peripheral device 1414. The address generator 1412 generates a sequence of non-contiguous addresses for indexing the target data and the direct memory access controller associated with the address generator 1412 is operable to read data from the memory 1410 according to an access ordering determined by the sequence of non-contiguous addresses. The data read from the memory 1410 in this non-contiguous ordering is then supplied to the peripheral device 1414 as the destination. The effect of reading the data from memory according to a non-contiguous address sequence is such that the destination data format differs form the source data format. In particular, the spatial pattern according to which data is stored in the memory 1410 is not reflected in the temporal ordering according to which the target data is supplied to the peripheral device. Accordingly, the address generator 1412 is capable of performing a data format transformation such that target data is delivered to the peripheral device in a temporal sequence associated with a different data format than the source data format according to which the target data is stored in the memory 1410.

FIG. 14B schematically illustrates transfer of data from a peripheral to a memory using an address generator according to the present technique. The arrangement comprises a peripheral device 1420, an address generator 1422 and a memory 1424. The peripheral device 1420 outputs data according to a predetermined sequence to the direct memory access controller associated with the address generator 1422. On receipt of the temporal sequence of data from the peripheral device 1420, the address generator 1422 sequentially indexes the data using a sequence of non-contiguous addresses, whose values are determined by the current iterator hierarchy and any address offsets within the address generator. The direct memory access controller writes the target data received from the peripheral device 1420 to the memory 1424 at memory addresses specified by the sequence of non-contiguous addresses produced by the address generator 1422. Thus the spatial locations at which target data output by the peripheral device is written to the memory 1424 are determined by the sequence of non-contiguous addresses so that the target data is supplied to the memory 1438 in a destination data format that differs from the source data format. The source data format is associated with the temporal sequence according to which data is output by the peripheral device 1420.

FIG. 14C schematically illustrates transfer of data from one memory to another memory using an address generator according to the present technique. The arrangement comprises a source memory 1430, a source address generator 1432, a data channel 1434, a destination address generator 1436 and a destination memory 1438. The source address generator 1432, the data channel 1434 and the destination address generator are all components of an associated direct memory access controller. The source address generator is operable to generate a sequence of memory addresses and the direct memory access controller reads data from the source memory 1430 according to this address sequence. The data read from the source memory 1430 is supplied via the data channel 1434 within the direct memory access controller to the destination address generator 1436. The destination address generator indexes data received (in a temporal sequence) via the data channel 1434 according to an address sequence that it generates and writes data to the destination memory 1438 at spatial locations according to the address sequence generated by the destination address generator 1436. The source address generator 1432 generates addresses using a set of source iterators, which perform a nested iteration in accordance with a source iterator hierarchy and the destination address generator 1436 generates addresses using a set of destination iterators, which perform a nested iteration in accordance with a destination iterator hierarchy. The hierarchical ordering of the set of source iterators differs from the hierarchical ordering of the set of destination iterators such that the spatial format in which the data is stored in the destination memory 1436 differs form the spatial format according to which data is stored in the source memory 1430.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A direct memory access controller operable to perform a data transfer to transfer target data from a source to a destination said target data being stored at said source in a source data format and said data transfer has an associated data transfer format defined by at least a sample size corresponding to a number of bits per data sample, a frame size corresponding to a number of samples per frame and a block size corresponding to a number of frames per block, said direct memory access controller comprising:
an address generator having a set of iterators comprising a sample iterator for counting said number of bits per sample, at least one frame iterator for counting said number of samples per frame and at least one block iterator for counting said number of frames per block, said address generator being operable to generate a sequence of non-contiguous addresses for indexing said target data by performing nested iteration of said set of iterators in accordance with an iterator hierarchy;
wherein said direct memory access controller is operable to access data from said source in accordance with a target data access ordering corresponding to said generated sequence of non-contiguous addresses and is operable to output said accessed data to said destination in an output temporal sequence corresponding to said target data access ordering and corresponding to a destination data format that differs from said source data format.

2. A direct memory access controller according to claim 1, wherein said direct memory access controller has a plurality of input ports for receiving said target data and said direct memory access controller comprises a plurality of said sets of iterators such that each set of iterators is associated with a single one of said plurality of input ports at a given time.

3. A direct memory access controller according to claim 1, wherein said direct memory access controller is coupled to a communication bus and is operable to service data transfer requests issued by at least one of a plurality of peripheral devices connected to said communication bus.

4. A direct memory access controller according to claim 1, wherein said sample size, said frame size and said block size are programmable.

5. A direct memory access controller according to claim 1, wherein said iterator hierarchy is programmable to produce different nested iterations.

6. A direct memory access controller according to claim 1, wherein at least one iterator of said set of iterators is configured to add an offset address during calculation of said sequence of non-contiguous addresses.

7. A direct memory access controller according to claim 1, wherein said target data comprises audio data and wherein, in said data format, said sample corresponds to an audio data sample, said frame corresponds to an audio data frame and said block corresponds to an audio data channel.

8. A direct memory access controller according to claim 1, wherein said sample iterator counts bits of an audio sample, said at least one frame iterator comprises a frame iterator for counting audio samples of an audio frame and said at least one block iterator comprises a block iterator for counting audio channels.

9. A direct memory access controller according to claim 7, wherein said wherein said non-contiguous address sequence is generated by transposition of said frame iterator and a first block iterator in said iterator hierarchy relative to a non-transposed iterator hierarchy corresponding to reproduction of a destination data format identical to said source data format.

10. A direct memory access controller according to claim 6, wherein said data format of said data to be transferred comprises one of the following audio formats: MP3, AAC, AC3, ISO/IEC 11172-3, ISO/IEC 13818-3, ISO/IEC 13818-7, ISO/IEC 14496-3, WMA, SBC and SSACD.

11. A direct memory access controller according to claim 1, wherein said data to be transferred comprises video data and in said data sample, said data format corresponds to a video sample, said frame corresponds to a macroblock comprising a plurality of lines and a plurality of columns of video samples and said block corresponds to a video frame.

12. A direct memory access controller according to claim 10, wherein said direct memory access controller comprises a first frame iterator for counting macroblock columns and a second frame iterator for counting macroblock rows, a first block iterator for counting a number of macroblocks per image line and a second block iterator for counting a number of macroblocks per image column.

13. A direct memory access controller according to claim 11, wherein said non-contiguous address sequence is generated by transposition of said second frame iterator and said first block iterator in said iterator hierarchy relative to a non-transposed iterator hierarchy corresponding to reproduction of a destination data format identical to said source data format.

14. A direct memory access controller according to claim 10, wherein said data format of said target data comprises one of the following video formats: MPEG, ISO/IEC 11172-2, ISO/IEC 13818-2, ISO/IEC 14496-2, ISO/IEC 14496-10, H.261, H.262, H.263, H.264 and WME.

15. A direct memory access controller operable to perform a data transfer to transfer target data from a source to a destination, said target data being stored at said source in a source data format and said data transfer has an associated data transfer format defined by at least a number of bits per data sample, a number of samples per frame and a number of frames per block, said direct memory access controller comprising:
an address generator having a set of iterators comprising a sample iterator for counting said number of bits per sample, at least one frame iterator for counting said number of samples per frame and at least one block iterator for counting said number of frames per block, said address generator being operable to generate a sequence of non-contiguous addresses for indexing said target data by performing nested iteration of said set of iterators in accordance with an iterator hierarchy;
wherein said direct memory access controller is operable to sequentially index a received sequence of target data from said source using said generated sequence of non-contiguous addresses and to supply said target data to said destination for storage at addresses corresponding to said generated sequence of non-contiguous addresses such that said target data is supplied to said destination in a destination data format that differs from said source data format.

16. A direct memory access controller according to claim 15, wherein said direct memory access controller has a plurality of input ports for receiving said target data and said direct memory access controller comprises a plurality of said sets of iterators such that each set of iterators is associated with a single one of said plurality of input ports at a given time.

17. A direct memory access controller according to claim 15, wherein said direct memory access controller is coupled to a communication bus and is operable to service data transfer requests issued by at least one of a plurality of peripheral devices connected to said communication bus.

18. A direct memory access controller according to claim 15, wherein said sample size, said frame size and said block size are programmable.

19. A direct memory access controller according to claim 15, wherein said iterator hierarchy is programmable to produce different nested iterations.

20. A direct memory access controller according to claim 15, wherein at least one iterator of said set of iterators is configured to add an offset address during calculation of said sequence of non-contiguous addresses.

21. A direct memory access controller according to claim 15, wherein said target data comprises audio data and wherein, in said data format, said sample corresponds to an audio data sample, said frame corresponds to an audio data frame and said block corresponds to an audio data channel.

22. A direct memory access controller according to claim 15, wherein said sample iterator counts bits of an audio sample, said at least one frame iterator comprises a frame iterator for counting audio samples of an audio frame and said at least one block iterator comprises a block iterator for counting audio channels.

23. A direct memory access controller according to claim 22, wherein said wherein said non-contiguous address sequence is generated by transposition of said frame iterator and a first block iterator in said iterator hierarchy relative to a non-transposed iterator hierarchy corresponding to reproduction of a destination data format identical to said source data format.

24. A direct memory access controller according to claim 21, wherein said data format of said data to be transferred comprises one of the following audio formats: MP3, AAC, AC3, ISO/IEC 11172-3, ISO/IEC 13818-3, ISO/IEC 13818-7, ISO/IEC 14496-3, WMA, SBC and SSACD.

25. A direct memory access controller according to claim 15, wherein said data to be transferred comprises video data and in said data sample, said data format corresponds to a video sample, said frame corresponds to a macroblock comprising a plurality of lines and a plurality of columns of video samples and said block corresponds to a video frame.

26. A direct memory access controller according to claim 25, wherein said direct memory access controller comprises a first frame iterator for counting macroblock columns and a second frame iterator for counting macroblock rows, a first block iterator for counting a number of macroblocks per image line and a second block iterator for counting a number of macroblocks per image column.

27. A direct memory access controller according to claim 26, wherein said non-contiguous address sequence is generated by transposition of said second frame iterator and said first block iterator in said iterator hierarchy relative to a non-transposed iterator hierarchy corresponding to reproduction of a destination data format identical to said source data format.

28. A direct memory access controller according to claim 25, wherein said data format of said target data comprises one of the following video formats: MPEG, ISO/IEC 11172-2, ISO/IEC 13818-2, ISO/IEC 14496-2, ISO/IEC 14496-10, H.261, H.262, H.263, H.264 and WME.

29. A direct memory access controller operable to perform a data transfer from a source to a destination said data transfer having an associated data format defined by at least a number of bits per data sample, a number of samples per frame and a number of frames per block, said direct memory access controller comprising:
a source address generator having a set of source iterators comprising a sample iterator for counting said number of bits per sample, at least one frame iterator for counting said number of samples per frame and at least one block iterator for counting said number of frames per block, said source address generator being operable to generate a sequence of source addresses for indexing said target data received from said source device by performing nested iteration of said set of source iterators in accordance with a source iterator hierarchy; and
a destination address generator having a set of destination iterators comprising a sample iterator for counting up to said number of bits per sample, at least one frame iterator for counting up to said number of samples per frame and at least one block iterator for counting up to said number of frames per block, said destination address generator being operable to generate a sequence of destination addresses for indexing said target data to be written to said destination device by performing nested iteration of said set of destination iterators in accordance with a destination iterator hierarchy;
wherein at least one of said source address generator and said destination address generator is operable to generate a non-contiguous sequence of addresses.

30. A direct memory access controller according to claim 29, wherein said direct memory access controller has a plurality of input ports for receiving said target data and said direct memory access controller comprises a plurality of said set of source iterators and a respective plurality of said set of destination iterators such that each set of source iterators and a corresponding set of destination iterators is associated with a single one of said plurality of input ports at a given time.

31. A direct memory access controller according to claim 29, wherein said destination iterator hierarchy is such that at least two of said sample iterator, said at least one frame iterator and said at least one block iterator are ordered within said hierarchy differently from the hierarchical ordering of corresponding iterators in said source iterator hierarchy such that said nested iteration corresponding to said destination iterator hierarchy differs from said nested iteration corresponding to said source iterator hierarchy.

32. A direct memory access controller according to claim 29, said direct memory access controller being coupled to a communication bus and being operable to service data transfer requests issued by at least one of a plurality of peripheral devices connected to said communication bus.

33. A direct memory access controller according to claim 29, wherein said sample size, said frame size and said block size are programmable.

34. A direct memory access controller according to claim 29, wherein said iterator hierarchy is programmable to produce different nested iterations.

35. A direct memory access controller according to claim 29, wherein at least one of said sample iterator, said frame interator and said block interator of at least one of said source address generator and said destination address generator is configured to add an offset address.

36. A direct memory access controller according to claim 29, wherein said data to be transferred comprises audio data and wherein, in said data format, said sample corresponds to an audio data sample, said frame corresponds to an audio data frame and said block corresponds to an audio data channel.

37. A direct memory access controller according to claim 29, wherein said sample iterator counts bits of an audio sample, said at least one frame iterator comprises a frame iterator for counting audio samples of an audio frame and said at least one block iterator comprises a block iterator for counting audio channels.

38. A direct memory access controller according to claim 37, wherein said transposition comprises transposition of said block iterator and said frame iterator.

39. A direct memory access controller according to claims 36, wherein said data format of said data to be transferred comprises one of the following video formats MP3, AAC, AC3, ISO/IEC 11172-3, ISO/IEC 13818-3, ISO/IEC 13818-7, ISO/IEC 14496-3, WMA, SBC and SSACD.

40. A direct memory access controller according to claim 29, wherein said data to be transferred comprises video data and in said data sample, said data format corresponds to a video sample, said frame corresponds to a macroblock comprising a plurality of lines and a plurality of columns of video samples and said block corresponds to a video frame.

41. A direct memory access controller according to claim 40, wherein said direct memory controller comprises a first frame iterator for counting macroblock columns and a second frame iterator for counting macroblock rows, a first block iterator for counting a number of macroblocks per image line and a second block iterator for counting a number of macroblocks per image column.

42. A direct memory access controller according to claim 41, wherein said transposition comprises transposition of said second frame iterator and said first block counter.

43. A direct memory access controller according to claim 40, wherein said data format of said data to be transferred comprises one of the following video formats MP3, AAC, AC3, ISO/IEC 11172-3, ISO/IEC 13818-3, ISO/IEC 13818-7, ISO/IEC 14496-3, WMA, SBC and SSACD.
